(19) United States
(12) Patent Application Publication
(10) Pub. No.: US 2023/0287896 A1
(43) Pub. Date: Sep. 14, 2023

(54) AXIAL FLOW FAN

(71) Applicant: Hanon Systems, Daejeon (KR)

(72) Inventors: Dae Suk PARK, Daejeon (KR); Myung Hoon KIM, Daejeon (KR)

(21) Appl. No.: 18/025,829

(22) PCT Filed: Sep. 10, 2021
(86) PCT No.: PCT/KR2021/012328

§ 371 Date: Mar. 10, 2023

(30) Foreign Application Priority Data
Sep. 29, 2020 (KR) 10-2020-0127460

(51) Int. Cl. F04D 29/32; F04D 29/38; F04D 19/00

(52) U.S. Cl. CPC F04D 29/329; F04D 29/384; F04D 19/002

(57) ABSTRACT

The present invention relates to an axial flow fan that is advantageous in terms of noise like a backward sweep fan while having excellent performance like a backward sweep fan, the axial flow fan including: a hub serving as the center of rotation; a plurality of blades disposed radially outside the hub, each having a blade root connected to an outer circumferential surface of the hub; and a fan band disposed outside the plurality of blades while a blade tip of each of the blades is connected thereto, wherein each of the blades includes: an inner blade positioned inside in a radial direction and bent in an opposite direction to a rotation direction of the axial flow fan; and an outer blade positioned outside in the radial direction and bent in the same direction as the rotation direction of the axial flow fan.

### TECHNICAL FIELD

The present invention relates to an axial flow fan in which air flows in a direction parallel to a rotation axis of the fan when the fan rotates.

### BACKGROUND ART

In general, in a vehicle, air blown by a blower fan is used to cool a heat exchange medium passing through inside of a heat exchanger such as a radiator or a condenser. In addition, as a blower fan for a vehicle, an axial flow fan in which air flows in a direction parallel to a rotation axis of the fan is mainly used.

FIGS. 1 and 2 are plan views each illustrating a conventional axial flow fan.

As illustrated, the conventional axial flow fan includes: a hub 10 serving as the center of rotation; a plurality of blades 20 disposed radially outside the hub 10 in a radial direction, each having a blade root connected to an outer circumferential surface of the hub 10; and a fan band 30 disposed outside the plurality of blades 20 in the radial direction while a blade tip of each of the blades 20 is connected thereto.

Such axial flow fans may be largely divided into backward sweep fans and forward sweep fans based on directions in which the fans rotate and directions in which blades (wings) are bent. That is, the forward sweep fan (FS fan) is an axial flow fan in which a direction in which the fan rotates is the same as a direction in which the blades 20 are bent as illustrated in FIG. 1, and the backward sweep fan (BS fan) is an axial flow fan in which a direction in which the fan rotates is opposite to a direction in which the blades 20 are bent as illustrated in FIG. 2.

Here, the forward sweep fan has relatively excellent performance because air flow streamlines do not overlap each other as illustrated in FIG. 3, but is disadvantageous in terms of noise. Thus, there is a demand from consumers for developing a backward sweep fan that is relatively advantageous in terms of noise.

However, the backward sweep fan is advantageous in terms of noise (sound), but as a result of flow analysis, air flows in a direction toward a blade tip along the shape of the blade as illustrated in FIG. 4, and vortices overlap and collide with each other in an area where the blade tip of the blade and the fan band meet each other, resulting in a deterioration in performance of the fan.

### RELATED ART DOCUMENT

### Patent Document

KR 10-0818407 B1 (Mar. 8, 2008)

### DISCLOSURE

### Technical Problem

An object of the present invention is to provide an axial flow fan that is advantageous in terms of noise like a backward sweep fan while having excellent performance like a backward sweep fan.

### Technical Solution

In one general aspect, an axial flow fan includes: a hub serving as the center of rotation; a plurality of blades disposed radially outside the hub, each having a blade root connected to an outer circumferential surface of the hub; and a fan band disposed outside the plurality of blades while a blade tip of each of the blades is connected thereto, wherein, based on a reference radius line SL connecting specific radial points to each other between the blade root and the blade tip, each of the blades includes: an inner blade positioned inside the reference radius line SL in a radial direction and bent in an opposite direction to a rotation direction of the axial flow fan; and an outer blade positioned outside the reference radius line SL in the radial direction and bent in the same direction as the rotation direction of the axial flow fan.

Each of the blades may have an angle θ1 in the opposite direction to the rotation direction of the axial flow fan, the angle θ1 being defined by a straight line L2 connecting the center C of the hub and the center C2 of the blade tip to each other with respect to a straight line L1 connecting the center C of the hub and the center C1 of the blade root to each other.

Each of the blades may have an angle θ2 in the same direction as the rotation direction of the axial flow fan, the angle θ2 being defined by a straight line L4 connecting an inflection point P, which is the center of an inflection portion where the inner blade and the outer blade meet each other, and the center C2 of the blade tip to each other with respect to a straight line L3 connecting the center C of the hub and the inflection point P to each other.

Each of the blades may have an angle θ3 in the opposite direction to the rotation direction of the axial flow fan, the angle θ3 being defined by the straight line L3 connecting the center C of the hub and the inflection point P, which is the center of the inflection portion where the inner blade and the outer blade meet each other, with respect to the straight line L1 connecting the center C of the hub and the center C1 of the blade root to each other.

A radius of the reference radius line SL of each of the blades may be formed at a point of ⅓ or more from the blade tip relative to a length from the blade tip to the blade root of the blade in the radial direction.

The inner blade may be curved in the opposite direction to the rotation direction of the axial flow fan.

The outer blade may be curved in the same direction as the rotation direction of the axial flow fan.

The inner blades of the plurality of blades may have the same length in the radial direction, and the outer blades of the plurality of blades may have the same length in the radial direction.

Intervals between adjacent ones of the plurality of blades may be equal.

Intervals between adjacent ones of the plurality of blades may not be equal.

Each of the blades may have a leading edge LE and a trailing edge TE extending from the blade root to the blade tip, and the leading edge LE and the trailing edge TE may be curved to correspond to each other.

### Advantageous Effects

The axial flow fan according to the present invention is advantageous in terms of noise because it has a good sound like a backward sweep fan, while having excellent performance like a backward sweep fan because streamlines do not overlap each other near the blade tip of the blade.

### DESCRIPTION OF DRAWINGS

FIGS. 1 and 2 are plan views illustrating a conventional forward sweep fan and a conventional backward sweep fan, respectively.

FIGS. 3 and 4 are images illustrating results of analyzing air flows near blade tips of blades of the conventional forward sweep fan and the conventional backward sweep fan.

FIGS. 5 and 6 are a plan view and a partially enlarged view each illustrating an axial flow fan according to an embodiment of the present invention.

FIG. 7 is an image illustrating pressure distribution on the blade in the conventional backward sweep fan.

FIG. 8 is an image illustrating pressure distribution on the blade in the axial flow fan according to an embodiment of the present invention.

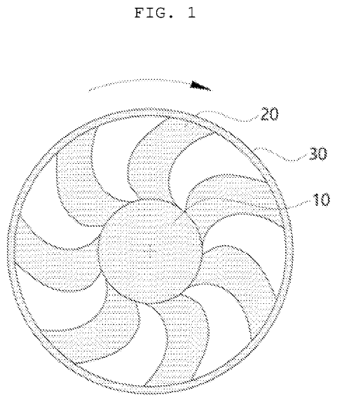

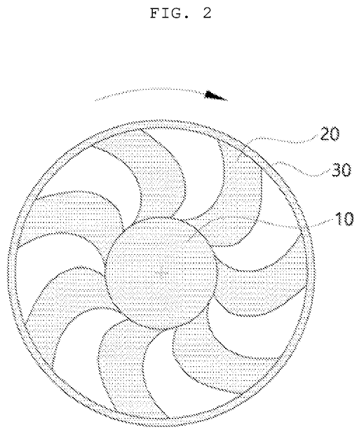

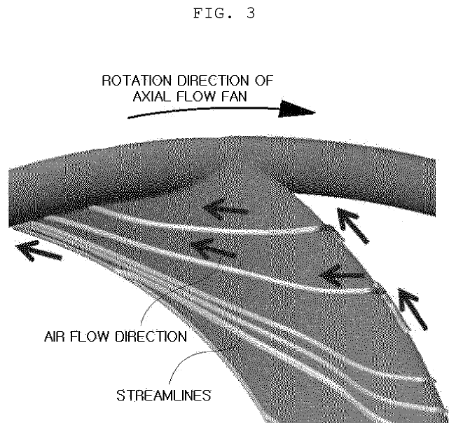

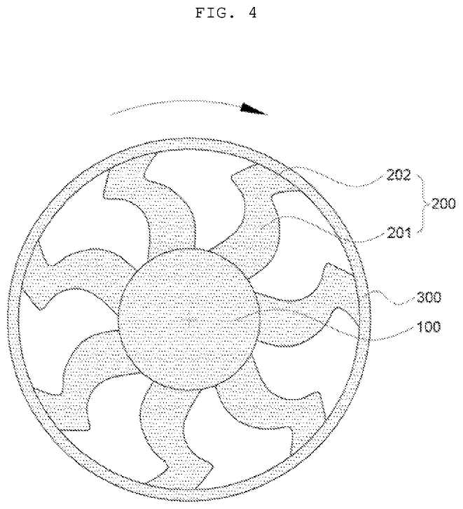

### BEST MODE

Hereinafter, the axial flow fan having the configuration as described above according to the present invention will be described in detail with reference to the accompanying drawings.

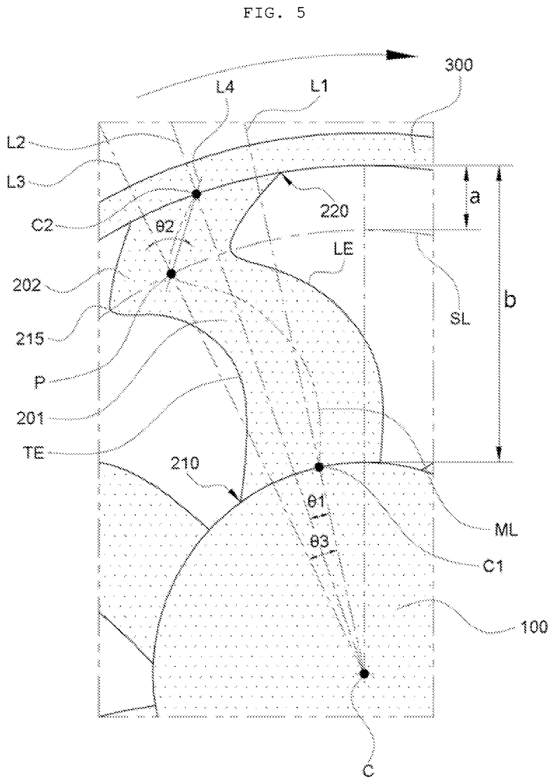

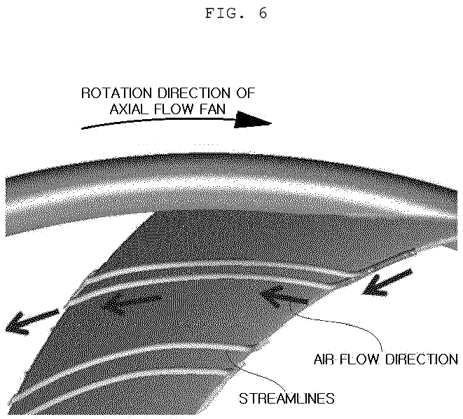

FIGS. 5 and 6 are a plan view and a partially enlarged view each illustrating an axial flow fan according to an embodiment of the present invention.

As illustrated, the axial flow fan according to an embodiment of the present invention may largely include a hub 100, a plurality of blades 200, and a fan band 300.

The hub 100 is a part serving as the center of rotation, and may be coupled to a driving shaft of a driving motor for rotation. For example, the hub 100 may be formed in a concave container shape to accommodate the driving motor inside, and may be formed in such a manner that a cylinder having a cylindrical shape extends in one direction from an outer circumstance of a disc-shaped plate to which the driving motor is coupled at the center thereof. In addition, the hub 100 may be formed in various shapes.

A plurality of blades 200 may be provided, and the plurality of blades 200 may be radially spaced apart from each other outside the hub 100 along a circumferential direction. In addition, the blades 200 may be formed in such a manner that the plurality of blades 200 extend outward in a radial direction from the hub 100, while a blade root 210, which is an innermost end of each of the blades 200 in the radial direction, is connected to a circumferential surface of the hub 100. In addition, when the axial flow fan rotates, in order to form an air flow direction to be the same as a rotation axis direction, each of the blades 200 may be formed to have a specific angle as an installation angle thereof, the installation angle being defined by a chord line, which is a straight line connecting a leading edge LE that is a front-side end of the blade in the rotation direction of the axial flow fan and a trailing edge TE that is a rear-side end of the blade in the rotation direction of the axial flow fan, with the rotation direction of the axial flow fan. In addition, in the blade 200, the center C1 of the blade root 210 and the center of the blade tip 220 may be located on a middle line ML continuing along the center between the leading edge LE and the trailing edge TE.

The fan band 300 may be formed in a ring shape, and the fan band 300 may be disposed outside the blades 200, such that the blade tip 220, which is an outermost end of each of the blades 200 in the radial direction, is connected onto an inner circumferential surface of the fan band 300. In this manner, the hub 100, the plurality of blades 200, and the fan band 300 may be integrally formed, for example, through injection molding or the like.

Here, each of the blades 200 may include an inner blade 201 positioned inside a reference radius line SL in the radial direction and an outer blade 202 positioned outside the reference radius line SL in the radial direction, and the inner blade 201 and the outer blade 202 may be integrally formed in such a manner that an inner end of the outer blade 202 is connected to an outer end of the inner blade 201 in the radial direction. That is, the reference radius line SL is a line connecting points where the inner blades 201 and the outer blades 202 of the respective blades 200 meet each other, and may form a circle having a specific radius with respect to the center C of the hub 100 serving as the center of rotation.

In addition, in each of the blades 200, the inner blade 201 may be formed to be bent in an opposite direction to the rotation direction of the axial flow fan, and the outer blade 202 may be formed to be bent in the same direction as the rotation direction of the axial flow fan. That is, when the rotation direction of the axial flow fan is clockwise as illustrated, the inner blade 201 may be formed to be bent to the left, which is in the counterclockwise direction, and the outer blade may be formed to be bent to the right, which is in the clockwise direction, such that the outer blade 202 is bent in the opposite direction to the direction in which the inner blade 201 is bent from the blade root 210 to the blade tip 220 of the blade 200.

More specifically, each of the blades 200 may have an angle θ1 in the opposite direction to the rotation direction of the axial flow fan, the angle θ1 being defined by a straight line L2 connecting the center C of the hub 100 and the center C2 of the blade tip 220 of the blade 200 to each other with respect to a straight line L1 connecting the center C of the hub 100 and the center C1 of the blade root 210 of the blade 200 to each other. That is, the blade 200 may be of a backward sweep fan (BS fan) type in which when the rotation direction of the axial flow fan is clockwise, the blade 200 is rotated in a state where the center of the blade tip 220 is positioned at the angle θ1 from the line L1 in the counterclockwise direction. In addition, each of the blades 200 may have an angle θ3 in the opposite direction to the rotation direction of the axial flow fan, the angle θ3 being defined by a straight line L3 connecting the center C of the hub 100 and an inflection point P, which is the center of an inflection portion 215 where the inner blade 201 and the outer blade 202 meet each other, with respect to the straight line L1 connecting the center C of the hub 100 and the center C1 of the blade root 210 of the blade 200 to each other. That is, the inner blade 201 may be rotated in a state where the inflection point P is positioned at the angle θ3 from the line L1 in the counterclockwise direction. At this time, the inflection point P may be located on the middle line ML.

In addition, each of the blades 200 may have an angle θ2 in the same direction as the rotation direction of the axial flow fan, the angle θ2 being defined by a straight line L4 connecting the inflection point P and the center C2 of the blade tip 220 of the blade 200 to each other with respect to the straight line L3 connecting the center C of the hub 100 and the inflection point P, which is the center of the inflection portion 215 where the inner blade 201 and the outer blade 202 meet each other. That is, the outer blade 202 may be rotated in a state where the blade tip 220 is positioned at the angle θ2 from the line L3 in the clockwise direction.

In this manner, in the axial flow fan according to an embodiment of the present invention, while each of the blades is generally formed in a backward sweep type in which the blade is bent in the opposite direction to the rotation direction of the axial flow fan, the inner blade may be formed in a backward sweep type and the outer blade may be formed in a forward sweep type. As a result, the axial flow fan according to an embodiment of the present invention is advantageous in terms of noise because it has a relatively good sound like a backward sweep fan, and also has excellent performance like a backward sweep fan because streamlines do not overlap each other near the blade tip of the blade.

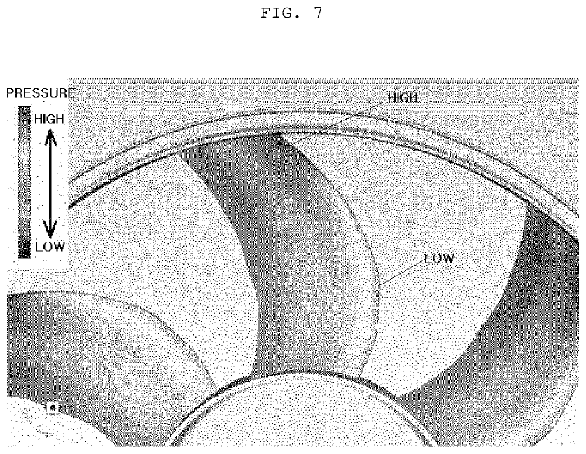

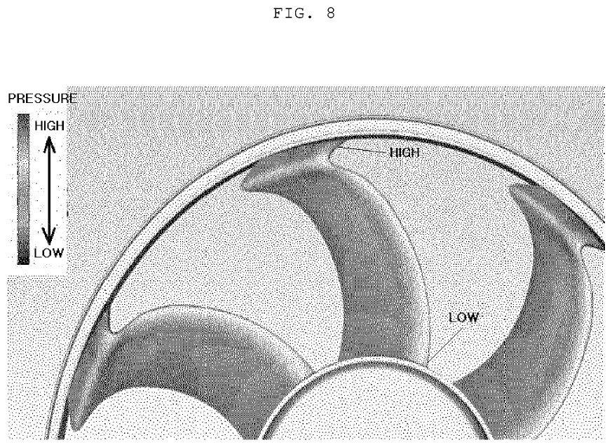

FIG. 7 is an image illustrating pressure distribution on a blade in a conventional backward sweep fan, and FIG. 8 is an image illustrating pressure distribution on the blade in the axial flow fan according to an embodiment of the present invention.

It can be seen that the pressure is concentrated near the blade tip of the blade in the conventional backward sweep fan as illustrated in FIG. 7, whereas the pressure is relatively evenly distributed over the entire blade in the axial flow fan according to the present invention as illustrated in FIG. 8, which makes it possible to improve performance and improve overall noise. In addition, based on fluid analysis test results, it has been confirmed that the axial flow fan according to the present invention has significantly improved performance (efficiency) as compared with the conventional backward sweep fan.

In addition, a radius of the reference radius line SL of each of the blades 200 may be formed at a point of ⅓ or more from the blade tip 220 relative to a length from the blade tip 220 to the blade root 210 of the blade 200 in the radial direction. That is, a distance (a) from the blade tip 220 of the blade 200 to the reference radius line SL in the radial direction may be ⅓ or more of a distance (b) from the blade tip 220 to the blade root 210 of the blade 200 {a≥(⅓)×b}.

In addition, the inner blade 201 may be formed to be curved in an opposite direction to the rotation direction of the axial flow fan. That is, the inner blade 201 may be formed in a backward curved type in which when the rotation direction of the axial flow fan is clockwise, the inner blade 201 is curved in the counterclockwise direction outward from the blade root 210 in the radial direction. In addition, the outer blade 202 may be formed to be curved in the same direction as the rotation direction of the axial flow fan. That is, the outer blade 202 may be formed in a forward curved type in which the outer blade 202 is curved in the clockwise direction outward from the inflection portion 215 in the radial direction.

Also, the inner blades 201 of the plurality of blades 200 may have the same length in the radial direction, and the outer blades 202 of the plurality of blades 200 may have the same length in the radial direction.

In addition, in the axial flow fan according to the present invention, intervals between adjacent ones of the plurality of blades may be equal. That is, the axial flow fan according to the present invention may be formed as an equiangular fan. In a case where the axial flow fan according to the present invention is formed as an equiangular fan, it is easy to adjust balance when the axial flow fan is manufactured by injection molding, but peak noise may be relatively high. Alternatively, in the axial flow fan according to the present invention, intervals between adjacent ones of the plurality of blades may not be equal. That is, the axial flow fan according to the present invention may be formed as a non-equiangular fan. In a case where the axial flow fan according to the present invention is formed as a non-equiangular fan, it is relatively difficult to adjust balance when the axial flow fan is manufactured by injection molding, but peak noise may be relatively reduced.

In addition, each of the blades 200 may have a curved shape in such a manner that the leading edge LE and the trailing edge TE extending from the blade root 210 to the blade tip 220 correspond to each other. In addition, the inner blade and the outer blade may be formed in various shapes and arrangements, and the cross section shape of the blade may also be formed in various blade shapes.

The present invention is not limited to the above-described embodiment, and may be applied in various forms. Various modifications may be made by any person having ordinary knowledge in the art to which the present invention pertains without departing from the gist of the present invention claimed in the claims.

### DESCRIPTION OF REFERENCE NUMERALS

100: hub, C: center of hub (center of rotation)
200: blade, 201: inner blade, 202: outer blade
210: blade root, C1: center of blade root, 215: inflection portion
P: inflection point, 220: blade tip, C2: center of blade tip
LE: leading edge, TE: trailing edge, ML: middle line
300: fan band, SL: reference radius line
L1: straight line connecting center of hub and center of blade root to each other
L2: straight line connecting center of hub and center of blade tip to each other
L3: straight line connecting center of hub and inflection point to each other

L4: straight line connecting inflection point and center of blade tip to each other
θ1: angle defined by L1 and L2
θ2: angle defined by L3 and L4
θ3: angle defined by L1 and L3

1. An axial flow fan comprising: a hub serving as the center of rotation; a plurality of blades disposed radially outside the hub, each having a blade root connected to an outer circumferential surface of the hub; and a fan band disposed outside the plurality of blades while a blade tip of each of the blades is connected thereto,
wherein, based on a reference radius line SL connecting specific radial points to each other between the blade root and the blade tip, each of the blades includes:
an inner blade positioned inside the reference radius line SL in a radial direction and bent in an opposite direction to a rotation direction of the axial flow fan; and
an outer blade positioned outside the reference radius line SL in the radial direction and bent in the same direction as the rotation direction of the axial flow fan.

2. The axial flow fan of claim 1, wherein each of the blades has an angle θ1 in the opposite direction to the rotation direction of the axial flow fan, the angle θ1 being defined by a straight line L2 connecting the center C of the hub and the center C2 of the blade tip to each other with respect to a straight line L1 connecting the center C of the hub and the center C1 of the blade root to each other.

3. The axial flow fan of claim 2, wherein each of the blades has an angle θ2 in the same direction as the rotation direction of the axial flow fan, the angle θ2 being defined by a straight line L4 connecting an inflection point P, which is the center of an inflection portion where the inner blade and the outer blade meet each other, and the center C2 of the blade tip to each other with respect to a straight line L3 connecting the center C of the hub and the inflection point P to each other.

4. The axial flow fan of claim 3, wherein each of the blades has an angle θ3 in the opposite direction to the rotation direction of the axial flow fan, the angle θ3 being defined by the straight line L3 connecting the center C of the hub and the inflection point P, which is the center of the inflection portion where the inner blade and the outer blade meet each other, with respect to the straight line L1 connecting the center C of the hub and the center C1 of the blade root to each other.

5. The axial flow fan of claim 1, wherein a radius of the reference radius line SL of each of the blades is formed at a point of ⅓ or more from the blade tip relative to a length from the blade tip to the blade root of the blade in the radial direction.

6. The axial flow fan of claim 1, wherein the inner blade is curved in the opposite direction to the rotation direction of the axial flow fan.

7. The axial flow fan of claim 1, wherein the outer blade is curved in the same direction as the rotation direction of the axial flow fan.

8. The axial flow fan of claim 1, wherein the inner blades of the plurality of blades have the same length in the radial direction, and the outer blades of the plurality of blades have the same length in the radial direction.

9. The axial flow fan of claim 1, wherein intervals between adjacent ones of the plurality of blades are equal.

10. The axial flow fan of claim 1, wherein intervals between adjacent ones of the plurality of blades are not equal.

11. The axial flow fan of claim 1, wherein each of the blades has a leading edge LE and a trailing edge TE extending from the blade root to the blade tip, and the leading edge LE and the trailing edge TE are curved to correspond to each other.
